(19) United States
(12) Patent Application Publication
(10) Pub. No.: US 2019/0196498 A1
(43) Pub. Date: Jun. 27, 2019

(54) SERVER DEVICE, VEHICLE-MOUNTED DEVICE, AND VEHICLE SYSTEM

(71) Applicant: Toyota Jidosha Kabushiki Kaisha, Toyota-shi Aichi-ken (JP)

(72) Inventors: Tomohito Matsuoka, Nagoya-shi Aichi-ken (JP); Seiichi Tsunoda, Nisshin-shi Aichi-ken (JP); Jiro Goto, Seto-shi Aichi-ken (JP); Masayuki Yamada, Chofu-shi Tokyo-to (JP); Yasutaka Eto, Okazaki-shi Aichi-ken (JP); Keima Fukunaga, Toyota-shi Aichi-ken (JP)

(21) Appl. No.: 16/223,309

(22) Filed: Dec. 18, 2018

(30) Foreign Application Priority Data
Dec. 26, 2017 (JP) 2017-250049

(51) Int. Cl. G05D 1/02; G05D 1/00; G01C 21/34; H04L 29/08

(52) U.S. Cl. CPC G05D 1/0276; G05D 1/0088; G05D 2201/0213; H04L 67/12; H04L 67/16; G01C 21/34

(57) ABSTRACT

A selection unit in a server device selects a service that a vehicle provides from a plurality of predetermined services. A communication unit transmits, to the vehicle, information acquired on a spot where a product is available.

### CROSS-REFERENCE TO RELATED APPLICATION

This application claims priority to Japanese Patent Application No. 2017-250049 filed on Dec. 26, 2017, incorporated herein by reference in its entirety.

### BACKGROUND

### 1. Technical Field

The present disclosure relates to server devices, vehicle-mounted devices, and vehicle systems for processing information related to vehicles.

### 2. Description of Related Art

Kitchen cars carrying a plurality of cooking ovens on a car body and allowing main and supplementary meals to be cooked while the car is traveling or at the destination are known (see, tor example, Japanese Registered Utility Model No. 3000542). Equipment like a fuel blending chamber, a combustion pan, an ignition electrode, a prewarming heater, etc. are provided in the cooking oven.

To build a kitchen car according to the above technology, an effort of collecting equipment necessary for cooking is required.

### SUMMARY

The embodiments address the above-described issue, and a general purpose thereof is to provide a server device, a vehicle-mounted device, and a vehicle system capable of reducing the effort of collecting products necessary to provide a service by using a vehicle.

A server device according to an embodiment includes: a selection unit configured to select a service that a vehicle provides from a plurality of predetermined services; an acquisition unit configured to acquire information on a spot where a product necessary to provide the service selected is available; and a communication unit configured to transmit, to the vehicle, the information acquired on the spot where the product is available.

According to this embodiment, it is possible, by allowing the vehicle to travel automatically via a spot where the product is available, to load the product in the vehicle at the spot where the product is available. Accordingly, the effort to collect products necessary to provide the service using the vehicle is reduced.

The selection unit may select, from the plurality of services, a further service that the vehicle provides when a condition to terminate provision of the service is met, the acquisition unit may acquire information on a spot where a product necessary to provide the further service selected is available, and the communication unit may transmit, to the vehicle, the information on the spot where the product necessary to provide the further service is available.

Another embodiment relates to a vehicle-mounted device. The device is mounted on a vehicle configured to provide a service and includes: an acquisition unit configured to acquire a traveling route from a starting point, via a spot where a product necessary to provide the service is available, to a destination where the product is mounted on the vehicle; and a vehicle controller configured to cause the vehicle to travel along the traveling route acquired.

Thus, by allowing the vehicle to travel along the traveling route automatically, it is possible to load the product in the vehicle at the spot where the product is available. Accordingly, the effort to collect products necessary to provide the service using the vehicle is reduced.

The vehicle may provide a further service when a condition to terminate provision of the service is met, the acquisition unit may acquire a further traveling route from a spot where the condition to terminate the provision of the service is met to the destination via the spot where a product necessary to provide the further service is available, and, when the condition to terminate the provision of the service is met, the vehicle controller may cause the vehicle to travel along the further traveling route acquired.

Still another embodiment relates to a vehicle system. The vehicle system includes: a server device; and a vehicle-mounted device mounted on a vehicle to provide a service and configured to communicate with the server device. The server device includes: a selection unit configured to select a service that the vehicle provides from a plurality of predetermined services; an acquisition unit configured to acquire information on a spot where a product necessary to provide the service selected is available; and a communication unit configured to transmit, to the vehicle, the information acquired on the spot where the product is available. The vehicle-mounted device includes: a communication unit configured to receive the information on the spot where the product is available; an acquisition unit configured to acquire a traveling route from a starting point, via the spot where the product is available, to a destination where the product is mounted on the vehicle; and a vehicle controller configured to cause the vehicle to travel along the traveling route acquired.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a perspective view schematically showing a vehicle according to an embodiment;

FIG. 2 is a block diagram, of a vehicle system including the vehicle of FIG. 1;

FIG. 3 is a block diagram showing a configuration of the server device of FIG. 2;

FIG. 4 is a block diagram showing a configuration of the vehicle-mounted device of FIG. 2; and

FIG. 5 shows a traveling route from a manufacturing factory of the vehicle of FIG. 1 to a sales outlet.

### DETAILED DESCRIPTION

An embodiment will now be described. The embodiment is illustrative and is not intended to toe limiting.

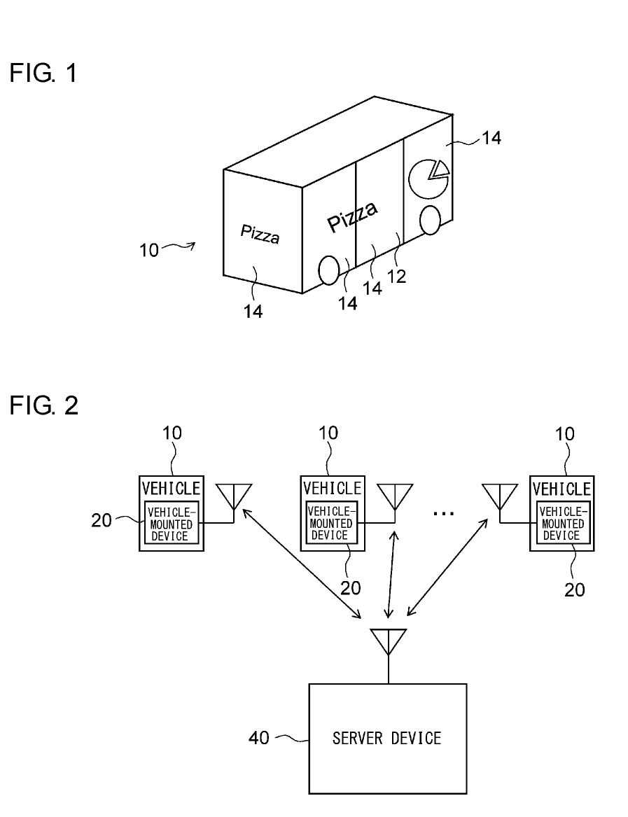

FIG. 1 is a perspective view schematically showing a vehicle 10 according to an embodiment. The vehicle 10 provides a predetermined service. The service is exemplified by, but not limited to, a drinking and eating service, a product sales service, a financial service, a medical care service, an energy supplying service, an administrative service, a transportation service, etc. Products carried on the vehicle 10 are defined in accordance with the service provided.

The vehicle 10 is exemplified by, but not limited to, an electric car. The vehicle 10 includes a door 12 and a plurality of display panels 14. For example, the door 12 is a sliding door provided at least on one side of the vehicle 10. The display panels 14 are provided on the front face, the side faces, and the rear face of the vehicle 10. The display panel 14 is also provided on the door 12. The display panel 14 displays an image related to the service that the vehicle 10 provides. For example, when the vehicle 10 provides a drinking and eating service, and, more particularly, a pizza sales service, the display panels 14 display a character “Pizza” and an image of pizza, relevant to the pizza sales service, as shown in FIG. 1.

The vehicle 10 is manufactured in a manufacturing factory. The vehicle 10 as manufactured in a manufacturing factory is provided with the functions for traveling but the vehicle 10 does not carry products necessary to provide a service. In a manufacturing factory, one type of vehicle 10 common to all kinds of services is manufactured. In other words, the vehicle 10 as manufactured in a manufacturing factory may be referred to as a base vehicle. A plurality of types of vehicles 10 of different sizes may be manufactured in a manufacturing factory.

FIG. 2 is a block diagram of a vehicle system 1 including the vehicle 10 of FIG. 1. The vehicle system 1 includes a plurality of vehicle-mounted devices 20 and a server device 40. FIG. 2 shows three vehicle-mounted devices 20 of a plurality of vehicle-mounted devices 20.

The vehicle-mounted device 20 is carried on the vehicle 10. The vehicle-amounted device 20 communicates wirelessly with the server device 40. The embodiment is non-limiting as to the standard for wireless communication. For example, wireless LAN, 3G (third-generation mobile communication system), 4G (fourth-generation mobile communication system), or 5G (fifth-generation mobile communication system) is covered. The vehicle-mounted device 20 may communicate wirelessly with the server device 40 via a base station (not shown).

For example, the server device 40 is provided at a manufacturing factory of the vehicle 10. The server device 40 configures a service that the vehicle 10 manufactured in the manufacturing factory should provide. The server device 40 may be provided in a data center or the like.

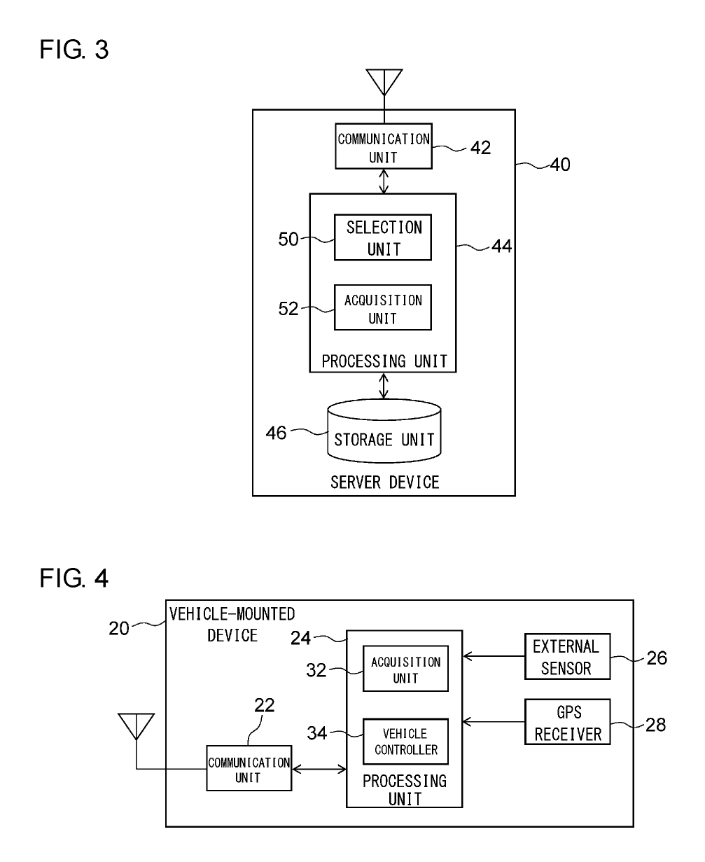

FIG. 3 is a block diagram showing a configuration of the server device 40 of FIG. 2. The server device 40 includes a communication unit 42, a processing unit 44, and a storage unit 46. The processing unit 44 includes a selection unit 50 and an acquisition unit 52.

The storage unit 46 stores information on a plurality of predetermined services, one or more products necessary to provide the services, spots where the products are available, the position of the manufacturing factory, the position of the sales outlet for the vehicle 10, and a map. The spots where the products are available are exemplified by sales outlets for the products. The sales outlet for the vehicle 10 is a shop for mounting a product on the vehicle 10 and is a shop for selling the vehicle 10 ready to provide the service. The spots where the products are available, the position of the manufacturing factory, the position of the sales outlet for the vehicle 10 each includes the latitude and the longitude.

The product necessary to provide the service differs depending on the service. In the case of pizza sales service, the products necessary to provide the service include, for example, a system kitchen, lighting equipment, a pizza oven, a table, and a chair.

When the production of the vehicle 10 is completed in the manufacturing factory, the selection unit 50 selects a service that the vehicle 10 provides from the plurality of services stored in the storage unit 46. Selection of a service is made in accordance with a predetermined production plan, information on the order from the client, etc. The selection unit 50 may select a service automatically or select a service in accordance with an instruction form a worker.

The acquisition unit 52 acquires from the storage unit 46 information on one or more products necessary to provide the selected service, spots where the products are available, the position of the manufacturing factory, the position of the sales outlet for the vehicle 10, and a map. The acquisition unit 52 acquires a traveling route from the position of the manufacturing factory that is a starting point to the position of the sales outlet at the destination via the spots where the products ere available. For example, the acquisition unit 52 acquires the shortest traveling route. For acquisition of the traveling route, a well-known route search technology may be used.

The communication unit 42 communicates wirelessly with a plurality of vehicle-mounted devices 20. The communication unit 42 transmits information on the selected service, the product, the spot where the product is available, the position of the sales outlet, and the traveling route to the target vehicle 10. Information for identifying the vehicle 10 at the destination of transmission is: attached to the above-listed items of information.

FIG. 4 is a block diagram showing a configuration of the vehicle-mounted device 20 of FIG. 2. The vehicle-mounted device 20 includes a communication unit 22, a processing unit 24, an external sensor 26, and a GPS receiver 28. The processing unit 24 includes an acquisition unit 32 and a vehicle controller 34.

The communication unit 22 communicates wirelessly with the server device 40. When the information on the service, the product, the spot where the product is available, the position of the sales outlet, and the traveling route has been transmitted from the server device 40 to the host vehicle, the communication unit 22 receives these items of information.

The external sensor 26 periodically detects information on obstacles such as a pedestrian around the host vehicle and outputs a result of detection to the processing unit 24. For example, the external sensor 26 includes at least one of a camera, LIDAR (Laser Imaging Detection and Ranging), and a radar.

The GPS receiver 28 receives a signal from an GPS satellite and calculates the position and orientation of the host vehicle. The position include the latitude and the longitude. The GPS receiver 28 outputs information on the position and orientation of the host vehicle to the processing unit 24.

The acquisition unit 32 acquires the information on the service, the product, the spot where the product is available, the position of the sales outlet, and the traveling route received by the communication unit 22.

The vehicle controller 34 causes the host vehicle to travel automatically along the traveling route by controlling the drive motor, the braking device, the steering device, etc. (not shown) in accordance with the information acquired by the acquisition unit 32 and the information on the position and orientation of the host vehicle. When it is determined that there are no obstacles in the direction of travel by referring to information on obstacles around the host vehicle detected by the external sensor 26, the vehicle controller 34 causes the host vehicle to move. For control, well-known automatic driving technology may be used.

When the host vehicle reaches a spot where a product is available according to the information acquired by the acquisition unit 32, the vehicle controller 34 causes the host vehicle to stop temporarily.

For example, a shop employee or a worker at the spot where the product is available loads the product in the vehicle 10 caused to stop temporarily. In this case, the vehicle-mounted device 20 may display information on the product that needs to be loaded on a display unit (not shown). The shop employee or the worker seeing the information can load the appropriate product in the vehicle 10.

When the product is loaded in the vehicle at the spot where the product is available, the vehicle controller 34 causes the host vehicle to travel to the spot in the traveling route where the next product is available or to the sales outlet for the vehicle 10. When the host vehicle reaches the position of the sales outlet acquired by the acquisition unit 32, the vehicle controller 34 cause the host vehicle to stop.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

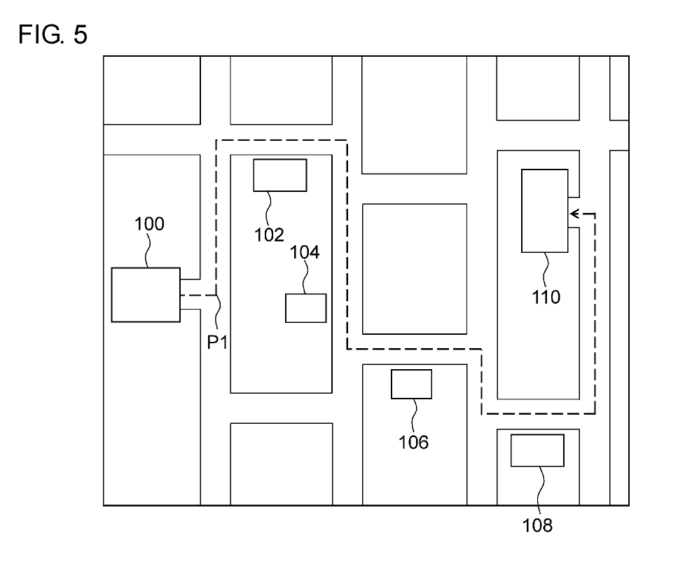

A description will now be given of an overall operation of the vehicle system 1 having the above configuration. FIG. 5 shows a traveling route P1 from a manufacturing factory 100 of the vehicle 10 of FIG. 1 to a sales outlet 110. The traveling route PI leads from the manufacturing factory 100 to the sales outlet 110 via spots 102˜108 where the products are available. The spot 102 where the product is available is a sales outlet where a system kitchen is available. The spot 104 where the product is available is a sales outlet where lighting equipment is available. The spot 106 where the product is available is a sales outlet where a pizza oven Is available. The spot 108 where the product is available is a sales outlet where a table and a chair are available.

When the vehicle 10 has been manufactured in the manufacturing factory 100, the vehicle-mounted device 20 of the vehicle 10 receives information including the traveling route P1 from the server device 40. The vehicle 10 travels along the traveling route P1 from the manufacturing factory 100 and stops at the spot 102 where the product is available. The system kitchen is loaded in the vehicle 10 here. Thereafter, the vehicle 10 travels along the traveling route PI and stops at the spot 104 where the product is available. The lighting equipment is loaded in the vehicle 10 here.

Similarly, the pizza oven is loaded in the vehicle 10 at the spot 106 where the product Is available, and the table and the chair are loaded in the vehicle 10 at the spot 108 where the product is available. Thereafter, the vehicle 10 travels along the traveling route PI and is parked at the sales outlet 110. At the sales outlet 110, the worker mounts the product loaded in the vehicle 10 on the vehicle 10. This makes the vehicle 10 ready to provide the pizza sales service.

Thus, according to this embodiment, the server device 40 selects a service provided toy the vehicle 10, acquires information on a spot where the product necessary to provide the selected service is available, and transmits, the acquired information on the spot where the product is available to the vehicle 10. Further, the vehicle-mounted device 20 acquires the traveling route leading to the destination where the product is mounted on the vehicle via the spot where the product necessary to provide the service is available. Thus, by allowing the vehicle 10 to travel along the traveling route automatically, it is possible to load the product in the vehicle 10 at the spot where the product is available. Accordingly, the effort to collect the products necessary to provide the service using the vehicle 10 is reduced.

### Second Embodiment

The second embodiment differs from the first embodiment in that the vehicle 10 provides a further service when a condition to terminate the provision of a service is met. The following description highlights the difference from the first embodiment.

The configuration of the vehicle system 1 is identical to that of the first embodiment so that an illustration is omitted. According to this embodiment, hourly rental of one vehicle 10 to a plurality of business operators is assumed. For example, the provision of a service may be terminated on the condition that the vehicle 10 arrives at a predetermined spot at a predetermined time and date or that a predetermined time and date has arrived. A description will be given below of a case where a bus service (transportation service) is provided at first, and, when the condition to terminate the bus service is met, a pizza sales service is provided by a further business operator as a further service. The condition for termination in this case requires that vehicle 10 arrives at a predetermined bus stop at a predetermined time and date. The predetermined time and date and the predetermined bus stop are defined by an agreement for hourly rental.

When the production of the vehicle 10 is completed in the manufacturing factory, the selection unit 50 of the server device 40 selects, in addition to a service that the vehicle 10 provides, a further service that the vehicle 10 provides when the condition to terminate the provision of the service is met, from the plurality of services stored in the storage unit 46. The selection unit 50 may select a further service while the vehicle 10 is providing a service and before the condition to terminate the provision of the service is met.

In addition to the information described in the first embodiment, the acquisition unit 52 acquires information on the condition to terminate the provision of the service, products necessary to provide the selected further service, and spots where the products are available. Based on the acquired information, the acquisition unit 52 acquires a further traveling route from the position of the predetermined bus stop where the condition to terminate the provision of the service is met to the position of the sales outlet for the vehicle 10 at the destination via the spots where the products necessary to provide the further service are available.

In addition to the information described in the first embodiment, the communication unit 42 transmits, to the vehicle 10, information on the condition to terminate the provision of the service, the further service, the products necessary to provide the further service, the spots where the products are available, and the further traveling route.

In addition to the information described in the first embodiment, the acquisition unit 32 of the vehicle-mounted device 20 acquires information, received by the communication unit 22, on the condition to terminate the provision of the service, the further service, the products necessary to provide the further service, the spots where the products are available, and the further traveling route. When the condition to terminate the provision of the service is met, the vehicle controller 34 causes the vehicle 16 to travel along the further traveling route acquired.

A description will now be given of an overall operation of the vehicle system 1 having the above configuration. As described in the first embodiment, the vehicle 10 manufactured in a manufacturing factory travels automatically to the sales outlet for the vehicle 10, picking up the products via the spots where the products necessary to provide the bus service are available. The products are exemplified by a chair, etc. The worker at the sales outlet 110 mounts the products loaded In the vehicle 10 on the vehicle 10. This makes the vehicle 10 ready to provide the bus service.

When the vehicle 10 provides the bus service and arrives at a predetermined bus stop at a predetermined time and date, and when the passengers leave the vehicle 10, the vehicle 10 travels along the further traveling route and travels automatically from the predetermined bus stop to the sales outlet for the vehicle 10, picking up the products via the spots where the products necessary to provide the pizza sales service are available. The worker at the sales outlet 110 removes the products necessary to provide the bus service and mounts the products loaded in the vehicle 10 and necessary to provide the pizza sales service on the vehicle 10. This makes the vehicle 10 ready to provide the pizza sales service.

Thus, this embodiment reduces the effort to collect the products necessary to provide the further service using the vehicle 10 when the condition to terminate the provision of a service is met and the further service is provided.

Described above is an explanation based on an exemplary embodiment. The embodiment is intended to be illustrative only and it will be obvious to those skilled in the art that various modifications to constituting elements and processes could be developed and that such modifications are also within the scope of the present disclosure.

For example, the acquisition unit 52 of the server device 40 may acquire the traveling route based on road information. The road information includes the position of a blocked road and a period of time elapsed until the road is unblocked. The server device 40 can acquire such road information form a further server (not shown) through wired or wireless communication. The further server refers to a terminal device etc. possessed by a worker to acquire information, entered by the worker, on the period of time elapsed until the road is unblocked and the position of the blocked road. The position of the blocked road may be the position where the road is under repair, the position where an accident is being dealt with, the position where a signal is being in trouble, the position where a fallen object is being removed, the position where a fallen tree is being dealt with, etc.

When it is predicted based on the speed of the vehicle 10 that the vehicle 10 arrives at the position of the blocked road before the period of time elapses, the acquisition unit 52 acquires a traveling route that does not pass the position of the blocked road. When it is predicted that the vehicle 10 arrives at the position of the blocked road after the period of time elapses, the acquisition unit 52 acquires the traveling route that passes the position of the blocked road, provided that the traveling route passing the position of the blocked road is the shortest.

According to this variation, the vehicle 10 can travel on an appropriate traveling route even if a road is blocked.

A carriage capable of traveling by being controlled by the vehicle-mounted device 20 may be mounted on the vehicle 10. The carriage has a loading device. The loading device includes, a robot hand capable of moving a product and carrying it onto the platform of the carriage. The processing unit 24 of the vehicle-mounted device 20 is provided with a loading controller that opens the door 12 of the vehicle 10 and causes the carriage to travel automatically to leave the vehicle 10 at a spot where the product is available. The loading controller loads the product in the vehicle 10 at the spot where the product is available by using the loading device of the carriage and based on the information on the product acquired by the acquisition unit 32. For example, an ID tag storing the information on the product is attached to the product, and the loading device reads the information in the IC tag and loads the necessary product onto the platform of the carriage based on the read information. The loading controller of the vehicle-mounted device 20 causes the carriage carrying the product into the vehicle 10 to load the luggage in the vehicle 10. According to this variation, the product is automatically loaded in the vehicle 10 at the spot where the product is available. The variation also eliminates the need for a worker who loads the product at the spot where the product is available.

A terminal device for receiving the information on the product necessary to provide the service from the server device 40, a loading device including a robot hand, and a carriage capable of traveling automatically may be provided at the spot where the product is available. In this case, the loading device loads the necessary product onto the platform of the carriage automatically before the vehicle 10 arrives, based on the information on the product received by the terminal device. Alternatively, the worker may load the product onto the platform of the carriage. The carriage moves automatically into the vehicle 10 when the vehicle 10 arrives at the spot where the product is available. When the carriage advances into the vehicle 10, i.e., when the product is loaded in the vehicle 10, the vehicle controller 34 causes the host vehicle carrying the carriage to travel to the spot, in the traveling route, where the next product is available or to the sales outlet for the vehicle 10. According to this variation, the product is automatically loaded at the spot where the product is available.

The acquisition unit 52 of the server device 40 may not acquire the traveling route, and the communication unit 42 may transmit information on the spot where the product is available and the destination to the vehicle 10. In this case, the acquisition unit 32 of the vehicle-mounted device 20 may acquire the traveling route based on the information received by the communication unit 22 and map information stored in a storage unit (not shown). According to this variation, the flexibility of the configuration ox the vehicle system 1 is improved.

What is claimed is:

1. A server device comprising:
a selection unit configured to select a service that a vehicle provides from a plurality of predetermined services;
an acquisition unit configured to acquire information on a spot where a product necessary to provide the service selected is available; and
a communication unit configured to transmit, to the vehicle, the information acquired on the spot where the product is available.

2. The server device according to claim 1, wherein
the selection unit selects, from the plurality of services, a further service that the vehicle provides when a condition to terminate provision of the service is met,
the acquisition unit acquires information on a spot where a product necessary to provide the further service selected is available, and
the communication unit transmits, to the vehicle, the information on the spot where the product necessary to provide the further service is available.

3. A vehicle-mounted device mounted on a vehicle configured to provide a service, comprising:
an acquisition unit configured to acquire a traveling route from a starting point, via a spot where a product necessary to provide the service is available, to a destination where the product is mounted on the vehicle; and
a vehicle controller configured to cause the vehicle to travel along the traveling route acquired.

4. The vehicle-mounted device according to claim 3, wherein
the vehicle provides a further service when a condition to terminate provision of the service is met,
the acquisition unit acquires a further traveling route from a spot where the condition to terminate the provision of the service is met to the destination via the spot where a product necessary to provide the further service is available, and,
when the condition to terminate the provision of the service is met, the vehicle controller causes the vehicle to travel along the further traveling route acquired.

5. A vehicle system comprising:
a server device; and
a vehicle-mounted device mounted on a vehicle to provide a service and configured to communicate with the server device, wherein
the server device comprises:
a selection unit configured to select a service that the vehicle provides from a plurality of predetermined services;
an acquisition unit configured to acquire information on a spot where a product necessary to provide the service selected is available; and
a communication unit configured to transmit, to the vehicle, the information acquired on the spot where the product is available, and
the vehicle-mounted device comprises:
a communication unit configured to receive the information on the spot where the product is available;
an acquisition unit configured to acquire a traveling route from a starting point, via the spot where the product is available, to a destination where the product is mounted on the vehicle; and
a vehicle controller configured to cause the vehicle to travel along the traveling route acquired.
